(19) United States
(12) Patent Application Publication
(10) Pub. No.: US 2015/0001865 A1
(43) Pub. Date: Jan. 1, 2015

(54) Vehicle Protector

(71) Applicants: Lance Avery McGee, SR., Lancaster, CA (US); Lance Avery McGee, JR., Lancaster, CA (US)

(72) Inventors: Lance Avery McGee, SR., Lancaster, CA (US); Lance Avery McGee, JR., Lancaster, CA (US)

(21) Appl. No.: 13/931,928

(22) Filed: Jun. 30, 2013

(51) Int. Cl. B60R 13/04

(52) U.S. Cl. CPC B60R 13/04
USPC 293/128; 293/117

(57) ABSTRACT

A car protector dimensioned and configured to protect car side panels from dings and dents caused by other cars, especially when the doors of the other cars are opened in a car parking lot. The protector is made of a durable, weather resistant outer material that encapsulates a foam type or inner material. The foam type material provides a cushion that dampens the force of a car door thus preventing the car door from damaging the side panel. A cable is attached to the car protector on one end and attaches to the car on an opposite end via suction cups. Magnets are disposed within the outer material and allow the protector to stay affixed to the car.

### BACKGROUND OF THE INVENTION

1. Field of the Invention

The present invention relates generally to car protectors, more specifically, the invention is related to protectors that protect the exterior side panels of automotive vehicles.

2. Description of the Prior Art

The use of door protectors to protect car doors from damage has been widely used in the art. Many have tried to devise protective covers for car side panels. These devices for the most part are bulky and ineffective, are attached to the side panels via cumbersome straps and ropes and are generally complicated or difficult to deploy.

The prior art includes the following patents U.S. Pat. No. 4,002,363, U.S. Pat. No. 4,561,685, U.S. Pat. No. 4,643,471, U.S. Pat. No. 4,674,783, U.S. Pat. No. 4,796,935, U.S. Pat. No. 4,828,302, U.S. Pat. No. 5,071,181, U.S. Pat. No. 5,072,979, U.S. Pat. No. 5,879,037, U.S. Pat. No. 6,179,354, and U.S. Des. 318,642.

The prior art disclosed above discloses car protectors that are bulky, difficult to secure to the car, attach via straps and are not easily deployed or stowed. None of the prior art teaches using a combination of magnets and suction cups to attach to both the exterior side panel and the interior of the car. None of the prior art patents teach, either by itself or in combination, the idea of a car protector that with ease of use and within a short duration of time can be affixed to the exterior or side panel of a car while simultaneously be securely attached to the car to prevent theft of the car protector. Furthermore, none of the prior art patents disclose a car protector that comprises a transparent compartment whereby advertisements can be displayed and seen by the passing public. In addition, the prior art does not disclose a car protector that has a re-sealable compartment whereby the protective foam like material can be replaced in the event it becomes brittle (for instance due to severe cold weather) or outdated (due to advances in protective materials like foam).

None of the above patents, taken either singly or in combination, is seen to describe the instant invention as claimed.

### SUMMARY OF THE INVENTION

Car owners across the United States know all too well the frustration and irritation experienced when returning to their parked cars at the mall or grocery store, only to find that an inconsiderate or inattentive person opened their car door too wide and put a ding or dent on their car. Some car owners resort to parking their cars in a diagonal manner to prevent others from parking adjacent to their car, thus irritating other car owners. People across this country take pride in their cars and spend hours keeping their cars in pristine conditions. Some car owners of today see their cars as an extension of themselves and take great pains to make sure their cars are in top condition, both inside and out. It follows then, that these car owners will often resort to drastic measures to insure that their cars look as good as possible. One way car owners are able to achieve this is via car protectors.

The car protector of the instant invention has a protective core material such as foam that is sufficient to prevent dings or dents from an opened door of an adjacent car. Surrounding the protective foam-like material is a durable cover made out of a leather type material that is weather and fire resistant. Secured between the durable cover and protective foam-like material are a plurality of magnets of sufficient attraction strength to hold the car protector to the side panel of the car when placed thereupon by the car owner. A wire or securing device has on one end a suction cup and on a second end means to hold the wire to the durable cover. The wire or securing device has one end that is attached to the car protector and another end that is secured or attached inside the car. When the car door is closed on the wire the wire, and therefore the car protector, is securely held in place and prevents theft of the car protector. The wire or securing device is thin enough to allow the car door to close properly, while also being of adequate tensile strength to prevent would-be thieves tearing or breaking the wire to steal the car protector.

The wire is secured or held to the interior of the car via securing devices such as suction cups, hook and loop type fasteners, clips or fasteners. This list is not conclusive and the items listed herein are merely for instructional purposes. The benefit of suction cups and hook and loop type fasteners is that the car owner can deploy the car protector and upon his return, easily remove the car protector as a single unit and stow it in the trunk of the car. However, it is possible that the car owner would like the end of the wire that attaches inside the car to be a permanent attachment and the car protector is slid under the driver's or passenger's seat when not in use. Either way, weather permanent or removable, the attachment allows the car protector to attach to the inside of the car.

The durable cover also has means by which the car owner can gain access to and remove the protective foam-like material. This is necessary for instances where due to extremely cold weather, the foam-like material has become brittle and either loses its ability to prevent dents or poses a threat itself to the car owner's door due to its loss of elasticity. The foam-like material may also need to be replaced due to advances in protective materials that may happen in the future. There are many means by which the car owner can gain access to the foam-like material within the durable cover. These means include, but are not limited to zippers, hook and loop type fasteners, magnetic clasps, buttons and belts.

Located along the outer side of the durable cover is a transparent sleeve that allows the car owner to slide or place an advertisement within the sleeve. The placement of the advertisement converts the car protector into a money-generating, dent preventing car protector.

There is, therefore, a need for a car protector that is comprised of a durable cover that contains therein a protective foam-like material and magnets to secure the car protector to the car, a way to gain access inside the durable cover to replace the foam-like material, a transparent cover allows for the display of advertisements and means by which the car protector can be secured to the car.

Accordingly, it is a principal object of the invention to provide a car protector that protects the car from dings or dents from other cars.

It is a further object of the invention to provide a car protector that has a foam-like material located within the durable cover.

Still another object of the invention is to have a wire or attachment device to securely attach the car protector to the car when the door is closed.

It is also an object of the invention to have a car protector with means to remove the protective foam-like material located within the durable cover.

Yet another object of the invention is to have a car protector with a sleeve that allows advertisements to be placed therein.

It is an object of the invention to provide improved elements and arrangements thereof in an apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

FIG. 1 is a front view of the preferred embodiment

FIG. 2 is a right side view of the preferred embodiment

FIG. 3 is a front view of the preferred embodiment

FIG. 4 is a front view of a second embodiment

FIG. 5 is a front view of the second embodiment

FIG. 6 is a front view of a third embodiment

FIG. 7 is a front view of a fourth embodiment

FIG. 8 is a front view of the preferred embodiment

FIG. 9 is a front view of the preferred embodiment

FIG. 10 is a front view of a fifth embodiment

FIG. 11 is a front view of a sixth embodiment

FIG. 12 is right side view of a fifth embodiment

FIG. 13 is right side view of a fifth embodiment

Similar reference characters denote corresponding features consistently throughout the attached drawings.

### DETAILED DESCRIPTIONS OF THE PREFERRED EMBODIMENTS

The invention relates to a car shield or car protector that is dimensioned and configured to attach along the side panel of a vehicle in order to protect that vehicle from dents. The car protector is comprised of an outer shell or cover made of a durable material such as leather or leather like material or canvas or any other material that is not easily punctured and will not scratch the car. Contained within the cover is a protective material that is both light weight and strong enough to prevent dents from happening. The protective material can be a foam or foam like material such as rubber. The durable material should be somewhat flexible and absorbent such that it can absorb much of the impact from a car door striking the car protector. Material that is rigid or has become rigid could potentially transfer the force of a car door striking the car protector onto the car owner's car therefore causing a dent in said car. In the case of the durable material becoming rigid due to age or extreme cold, the car protector is equipped with means to access and replace the durable material with new material and then seal the protective cover. Even if the durable material has not become rigid the means to access and replace the material would be used should advances in material science bring about better material. The car protector can also function as a money making device by using the transparent sleeve and placing advertisements therein.

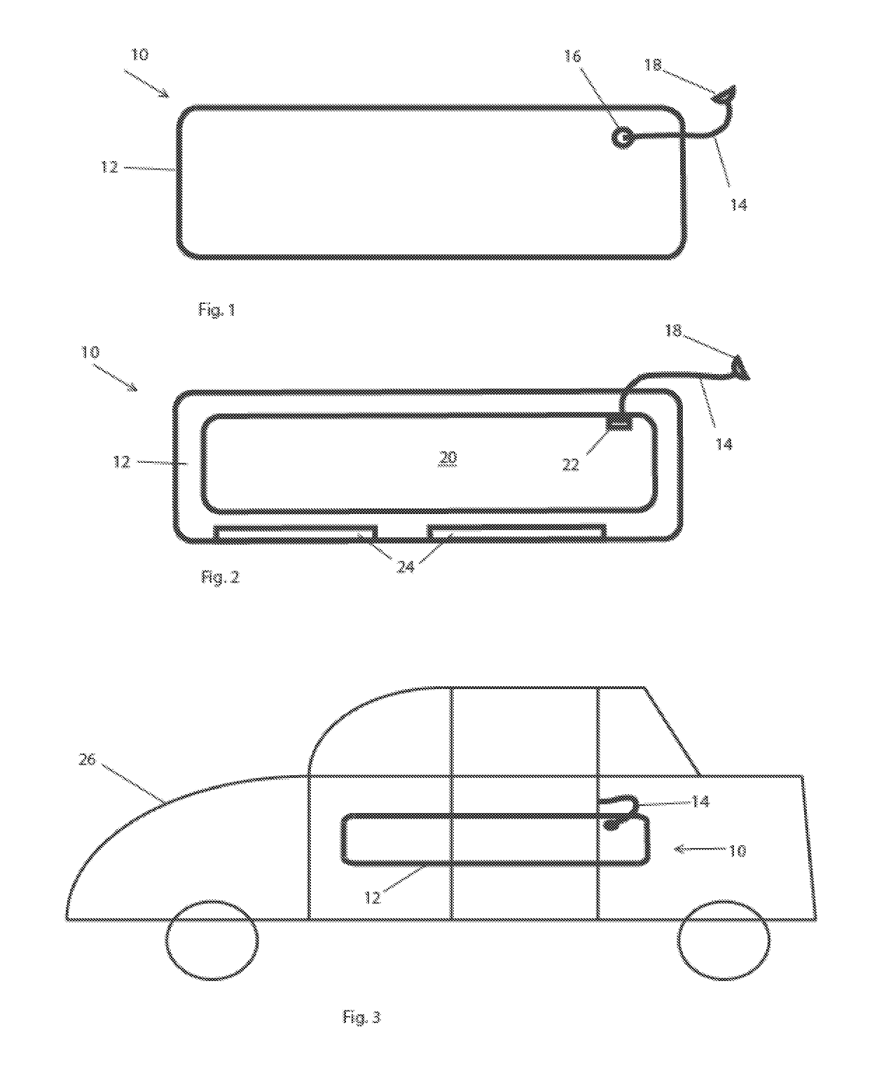

Turning now to FIGS. 1, 2 and 3 of the drawings, car protector 10 is shown attached to car 26 and having a cover 12, a wire or cable 14, a hole or grommet 16 located on cover 12 whereby wire 14 extrudes from and a suction cup 18 at the end of wire 14. The wire 14 should have a small enough diameter such that the car door can close properly. Wire 14 should also be strong enough to not easily break. An example of such a wire would be airplane wire that is light weight, has a small diameter and has a high tensile strength. Located within cover 12 is protective material 20 and attached to cover 12 are a plurality of magnets 24. Magnets 24 are used to removably attach car protector 10 to the car 26. Securing means 22 attach wire 14 to cover 12. The securing means 22 could comprise gluing or stitching or fastening or bonding the wire 16 to cover 12. To secure the car protector 10 to the car 26, the owner would simply affix car protector 10 to the side of car 26 and allow magnets 24 to attach to the side panel of car 26. The owner, would then affix suction cup 18 inside car 26 has to door to car 26 is closed on wire 14, thus securing car protector 10 onto car 26 first by means of magnets 24 then by means of the car door closing on wire 14.

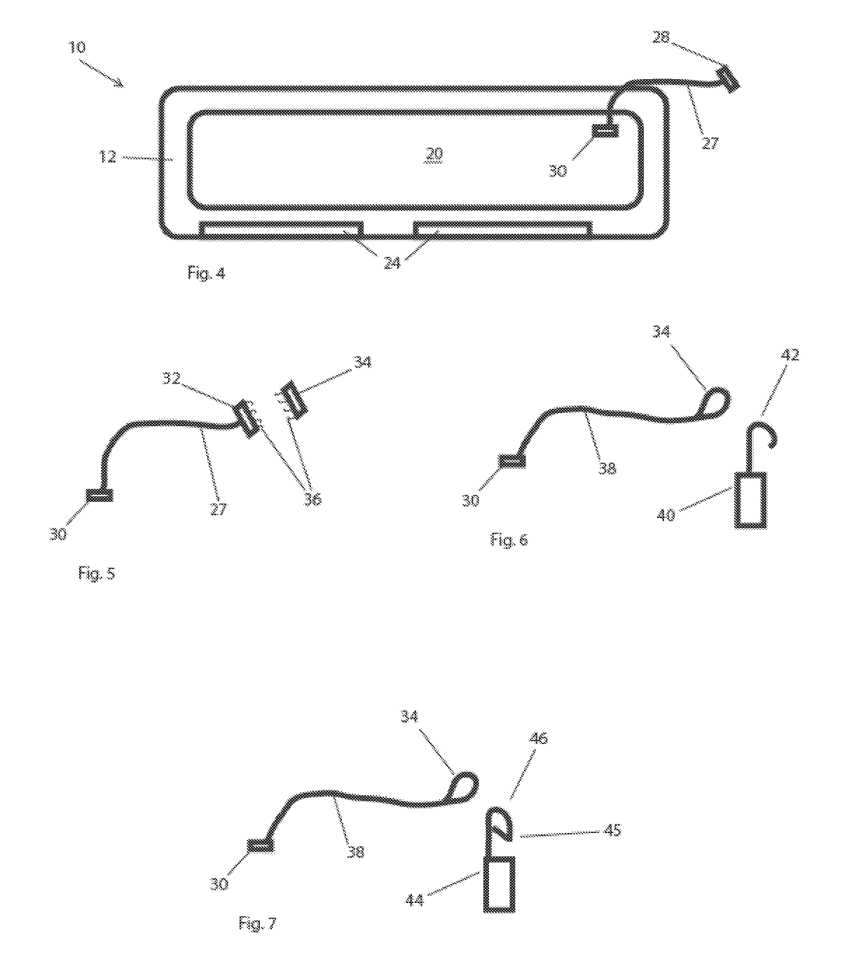

FIGS. 4, 5, 6 and 7 show different embodiments of the invention. Wire 26 is shown having a block 30 on one end and a magnet 28 on a second end. The block 30 prevents wire 27 from becoming disengaged with cover 12 whereas magnet 28 is used to attach to the interior of the car. FIG. 5 shows yet another embodiment wherein wire 27 is attached on a second end to a first base 32 which can be attached to a second base 34 via hook and loop type fasteners 36. FIG. 6 shows wire 38 having a loop 34a on one end and a hook 42 attached to a base 40. Base 40 (as well as base 34 and base 44) is attached to the interior of the car. To make the attachment, the owner would place loop 34 over hook 42. FIG. 7 shows the same loop 34 except here it attaches to clamp 46 having a base 44 and clasp 45.

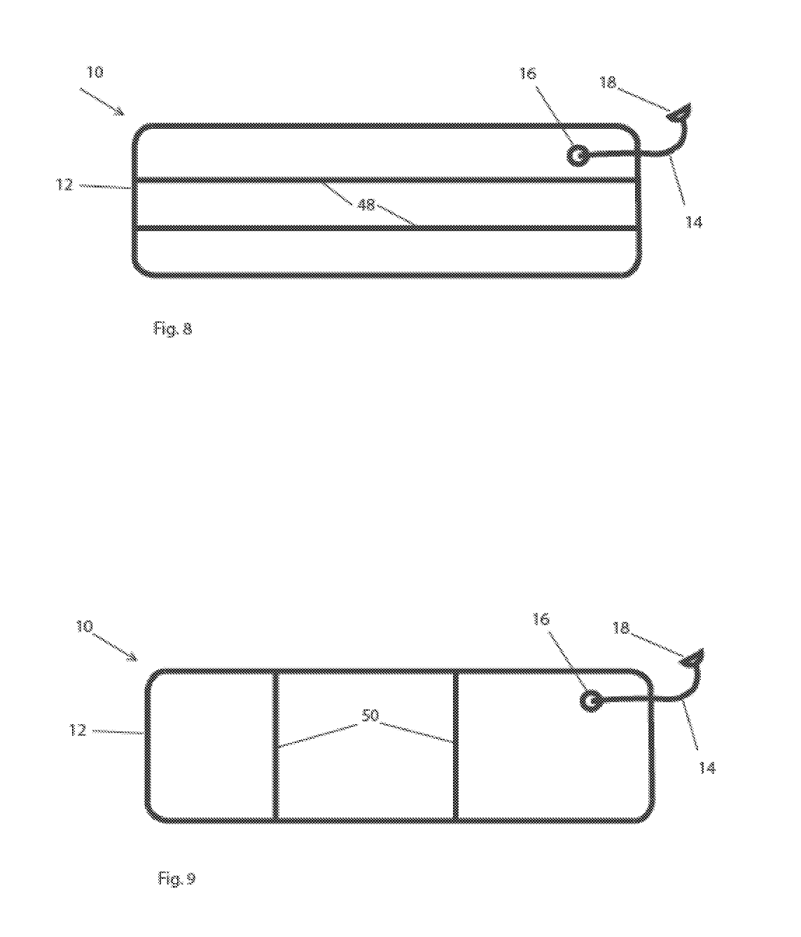

FIG. 8 shows a car protector 10 having access means 48 that allow the owner to gain access to the protective material 20 (of FIG. 2.) in order to replace protective material 20 when and if necessary. The access means can be anything that allows the cover to be opened and closed securely, such as zippers, buttons, hook and loop type fasteners and magnets, just to name a few. FIG. 8 shows a transparent sleeve 50 that can be used to place advertisements onto cover 12 that can be seen by the public.

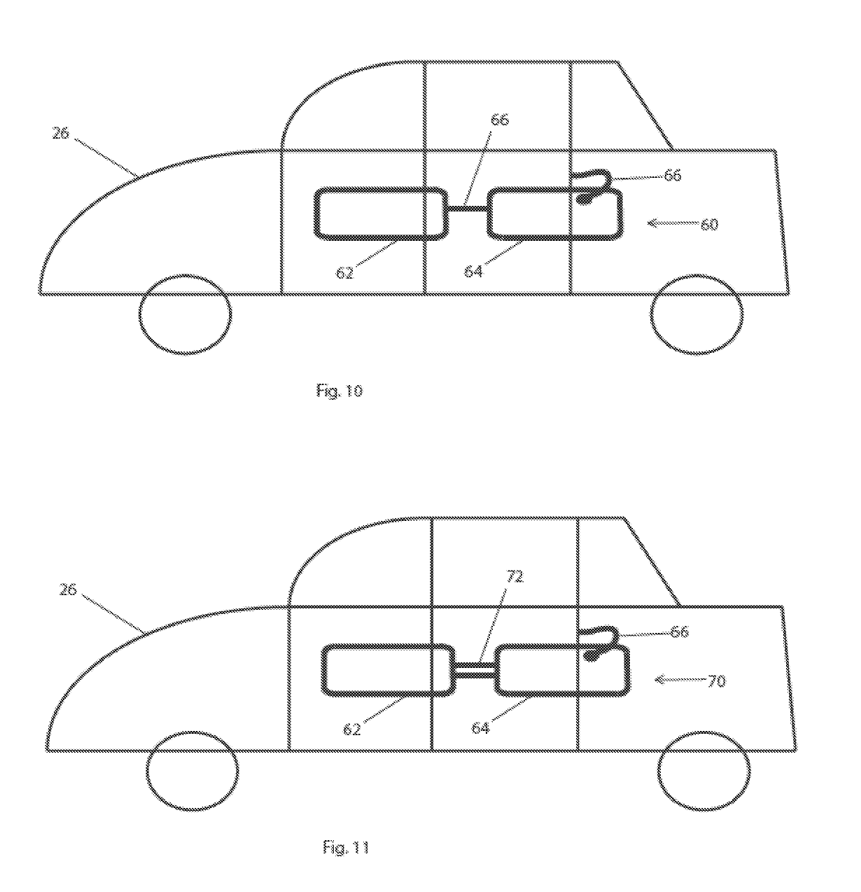

FIG. 10 illustrates a first car shield assembly 60 having a first car shield 62 attached to a second car shield assembly 64 via cable 66. Cable 66 is attached on a first end to the interior of the car in a similar way as shown in FIGS. 1 and 2 of the drawings. By combining multiple car shields into a single product the user can protect both side doors with a single device. Although shown here with only two car shields attached together, a plurality of car shields could be daisy chained together to cover the elongated sides of vehicles like limos or vans. FIG. 11 of the drawings shows a second car shield assembly 70 wherein the first car shield 62 is attached to the second car shield 64 via a strap 72.

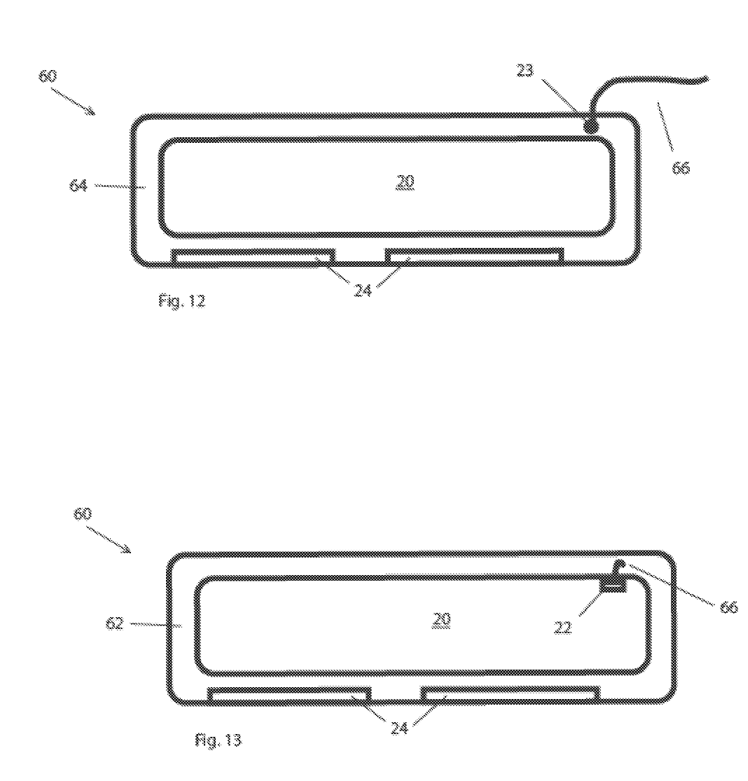

FIG. 12 shows a cross section of the second car shield 64 wherein the cable 66 is show entering the second car shield 64 and running along the length of it in hole 23. Magnets 24 attached to the bottom of second car shield 64 secure the car shield 64 to the car. FIG. 13 shows a first car shield 62 wherein cable 66 is attached via securing means 22. The securing means 22 could comprise gluing or stitching or fastening or bonding. Magnets 24 attached to the bottom of first car shield 62 secure the car shield 62 to the car. Protective material 20 is located within first car shield 62 and second car shield 64.

As with car protector 10, car shield assembly 60 also has access means that allow the owner to gain access to the protective material in order to replace it when and if necessary. Also, the access means can be anything that allows the cover to be opened and closed securely, such as zippers, buttons, hook and loop type fasteners and magnets. Similarly, a transparent sleeve located on first and second car shields can be used to place advertisements thereto. It is to be understood that first car shield 62 and second car shield 64 are essentially designed the same way as car protector 10 with modifications that allow them to be daisy chained.

It is to be understood that the present invention is not limited to the sole embodiment describes above, but encompasses any and all embodiments within the scope of the following claims.

I claim:

1. A car protector to prevent a car from getting dents comprising;
a cover dimensioned and configured to protect the side of a car,
attachment means to attach said cover to the car,
and first securing means to secure said cover to the car.

2. The car protector according to claim 1 further comprising;
a protective material located within said cover,
and said first securing means comprising magnets.

3. The car protector according to claim 2 further comprising;
said first securing means located within said cover,
said first securing means attached to said cover,
and said cover having a hole by which said attachment means goes through.

4. The car protector according to claim 3 further comprising;
said attachment means comprising a wire,
wherein said wire has a first end and a second end wherein said first end is attached to said cover and said second end is attached to the car,
wherein the car has a door,
wherein the car has an interior,
and wherein said wire being dimensioned and configured such that the door of the car can close properly.

5. The car protector according to claim 4 further comprising;
said second end of said wire being attached to the interior of the car,
said second end of said wire having a suction cup,
and said first end of said wire having second securing means to secure said wire to said cover.

6. The car protector according to claim 5 further comprising means to access and replace said protective material within said cover.

7. The car protector according to claim 6 further comprising a transparent sleeve located on said cover so that advertisements may be placed within said sleeve.

8. The car protector according to claim 4 further comprising;
said second end of said wire being attached to the interior of the car,
said second end of said wire having a magnet,
said first end of said wire having a block that prevents said first end from going through said hole,
said means to access and replace said protective material within said cover,
and a transparent sleeve located on said cover so that advertisements may be placed within said sleeve.

9. The car protector according to claim 4 further comprising;
said second end of said wire being attached to the interior of the car,
said second end of said wire having hook and loop type fasteners,
said first end of said wire having a block that prevents said first end from going through said hole,
said means to access and replace said protective material within said cover,
and a transparent sleeve located on said cover so that advertisements may be placed within said sleeve.

10. The car protector according to claim 4 further comprising;
said second end of said wire being attached to the interior of the car,
a base and a hook attached to said base wherein said base is attached to the interior of the car,
said second end of said wire having a loop,
said first end of said wire having a block that prevents said first end from going through said hole,
said means to access and replace said protective material within said cover,
and a transparent sleeve located on said cover so that advertisements may be placed within said sleeve.

11. The car protector according to claim 4 further comprising;
said second end of said wire being attached to the interior of the car,
a base and a clasp attached to said base wherein said base is attached to the interior of the car,
said second end of said wire having a loop,
said first end of said wire having a block that prevents said first end from going through said hole,
said means to access and replace said protective material within said cover,
and a transparent sleeve located on said cover so that advertisements may be placed within said sleeve.

12. A car protector to prevent a car from getting dents comprising;
a plurality of covers dimensioned and configured to protect the side of a car,
attachment means to attach said plurality of covers to the car,
first securing means to secure said plurality of covers to the car,
and second securing means to secure said plurality of covers to the car.

13. The car protector according to claim 12 wherein said plurality of covers comprise a first car shield and a second car shield.

14. The car protector according to claim 13 further comprising;
a first protective material located within said first car shield,
a second protective material located within said second car shield,
said first securing means comprising magnets,
and said second securing means comprising magnets.

15. The car protector according to claim 14 further comprising;
said first securing means located within said first car shield,
said first securing means attached to said first car shield,
said second securing means located within said second car shield,
said second securing means attached to said second car shield,
and said first car shield having a hole by which said attachment means goes through.

16. The car protector according to claim 15 further comprising;
said attachment means comprising a wire,
wherein said wire has a first end and a second end wherein said first end is attached to said first car shield and said second end is attached to the car,
wherein the car has a door,
wherein the car has an interior,
and wherein said wire being dimensioned and configured such that the door of the car can close properly.

17. The car protector according to claim 16 wherein said first car shield is connected to said second car shield via connecting means.

18. The car protector according to claim 17 further comprising;
a first access means to access and replace said first protective material within said first car shield,
a second access means to access and replace said second protective material within said second car shield,
a first transparent sleeve located on said first car shield so that advertisements may be placed within said first transparent sleeve,
and a second transparent sleeve located on said second car shield so that advertisements may be placed within said second transparent sleeve.

19. The car protector according to claim 18 further comprising;
said connecting means comprise a strap,
said second end of said wire being attached to the interior of the car,
said second end of said wire having a suction cup,
and said first end of said wire having third securing means to secure said wire to said first car shield.

20. The car protector according to claim 18 further comprising;
said connecting means comprise a cable,
said second end of said wire being attached to the interior of the car,
said second end of said wire having a suction cup,
and said first end of said wire having third securing means to secure said wire to said first car shield.
